(19) United States
(12) Patent Application Publication
(10) Pub. No.: US 2004/0249728 A1
(43) Pub. Date: Dec. 9, 2004

(54) System and method for global inventory querying

(76) Inventor: Po-Hsuan Wu, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/839,837

(22) Filed: May 5, 2004

(30) Foreign Application Priority Data
May 5, 2003 (TW) 92112258

(51) Int. Cl. G06F 17/60

(52) U.S. Cl. 705/28

(57) ABSTRACT

A system for global inventory querying includes a server (1), and a number of workstations (3) connected with the server via a network (4). Each of the workstations is located in a corresponding warehouse, and connects with a branch database (7) storing data on inventory of the warehouse. The server connects with a second database (6) storing user data. The server includes a data mining module (30), a query module (40), and a report sending module (60). A related method includes the steps of: providing a workstation at each physical warehouse; providing a server connected with a second database; mining inventory data from the branch databases, and storing the data in the second database; providing a graphic query interface for querying inventory data in image forms; and generating a form report on inventory, and sending the form report to a corresponding user.

### BACKGROUND OF THE INVENTION

1. Field of the Invention

The present invention relates to a computer data processing system in a management information system, and especially to a system and method for global inventory querying employing distributed computers.

2. Background of the Invention

Globalized economic development has brought tremendous business opportunities to numerous enterprises, and has also brought more pressure to bear on manufacturing enterprises. Warehouses of manufacturing enterprises service raw materials suppliers, manufacturing premises, distribution departments, forwarders, and other providers. A large manufacturing enterprise may have warehouses located all over the world. Efficient tracking of inventory of each warehouse enables materials and products to be delivered in time, and achieves high customer satisfaction. In addition, efficient tracking of inventory ensures that adequate buffer stocks are kept at all times, and that such buffer stocks are not inherently excessive.

The advent of the internet has made it possible to track inventory of distributed warehouses in real time. For example, Taiwan patent issue No. 509850 entitled “Remote Data Querying System By Using Electronic Mails” discloses a system for querying data stored in a remote database and returning query results in real time by electronic mail. The system uses keywords to query data stored in the remote database or a remote document, and the returned query results may be received by a personal computer or a mobile phone.

However, the remote database of the above-described system is a simple database, and the query results are not necessarily provided in user-friendly form. In addition, the use of keywords can be unduly cumbersome and time-consuming.

### SUMMARY OF THE INVENTION

Accordingly, an objective of the present invention is to provide a system for global inventory querying which can efficiently query inventory data stored in remote databases.

Another objective of the present invention is to provide a method for global inventory querying which can efficiently query inventory data stored in remote databases.

In order to achieve the first above-mentioned objective, a system for global inventory querying in accordance with the present invention comprises a server, and a plurality of workstations connected with the server via a network. Each of the workstations is located in a corresponding warehouse, and connects with a respective branch stored data on inventory of the warehouse. The server connects with a central database stored user data. The user data comprise contents of form reports that corresponding users require, electronic mail details of the users, and times of sending form reports. The server further comprises a data mining module for mining inventory data from the branch databases and storing the data to the central database, a query module with a graphic query interface for querying inventory data, and a report sending module for sending form reports to corresponding users.

In order to achieve the second above-mentioned objective, a method for global inventory querying in accordance with the present invention comprises the steps of: (a) providing a workstation at each of warehouses, each of the workstations connecting with a respective branch database for storing inventory data on the warehouse; (b) providing a server connected with a central database, for storing data on users, contents of form reports, electronic mail details, and times of sending form reports; (c) mining inventory data from the branch databases, and storing the mined data in the central database; (d) providing a graphic query interface for querying inventory data in image forms; and (e) generating a form report on inventory, and sending the form report to a corresponding user.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for global inventory querying in accordance with a preferred embodiment of the present invention, the system comprising a plurality of client computers, a server, a databases, and a plurality of workstations and branch database;

FIG. 2 is a block diagram of function modules of the server of FIG. 1;

FIG. 3 is a data flow chart of the system for global inventory querying;

FIG. 4 is an exemplary querying website of the system for global inventory querying; and

FIG. 5 is a flow chart of the system for global inventory querying.

### DETAILED DESCRIPTION OF PREFERRED EMBODIMENTS OF THE INVENTION

Reference will now be made to the drawings to describe the present invention in detail.

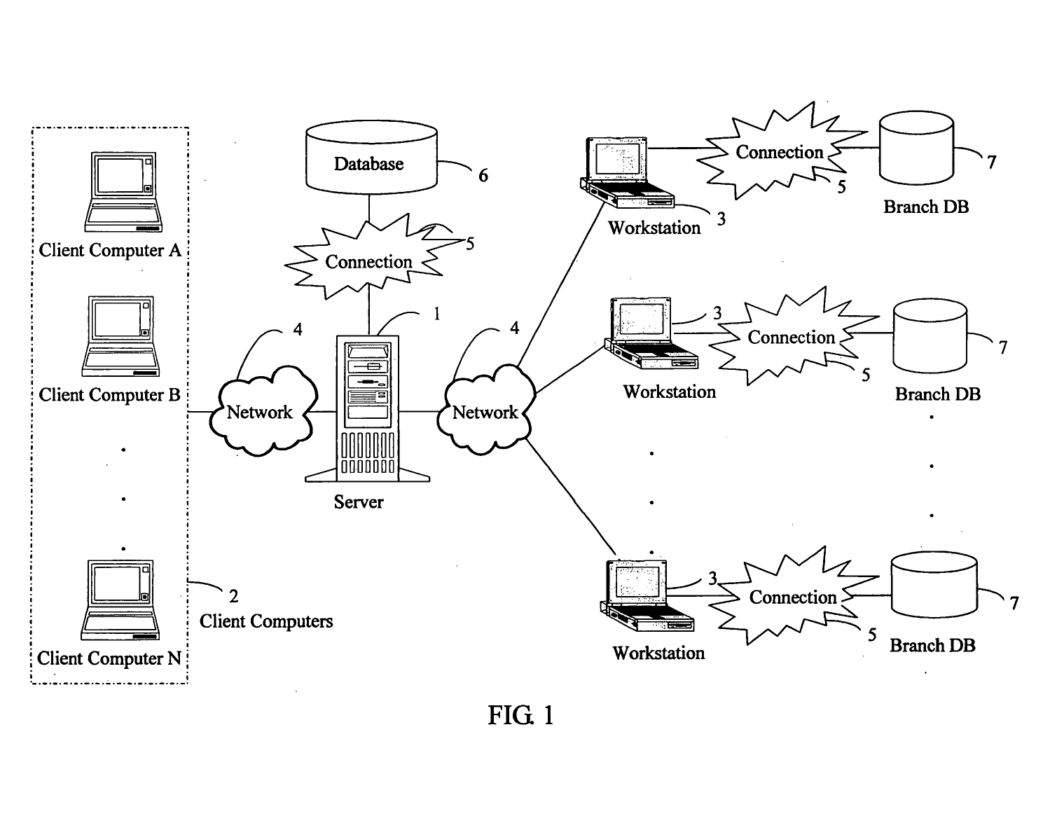

FIG. 1 is a schematic diagram of hardware configuration of a system for global inventory querying in accordance with the preferred embodiment of the present invention. The system for global inventory querying comprises a three-layer information system. The three-layer information system comprises a data access layer, a business logic layer, and a presentation layer. The data access layer comprises a database 6 and a plurality of branch databases 7. The business logic layer comprises a server 1. The presentation layer comprises a plurality of client computers 2 and workstations 3. For the purposes of conveniently illustrating the preferred embodiment of the present invention, generally, only one client computer 2, one workstation 3 and one branch database 7 are described hereinafter. Networks 4 interconnect the business logic layer and the presentation layer. The networks 4 can each be the internet, an intranet or another kind of electronic communication network. Connections 5 interconnect the data access layer and the business logic layer. The connections 5 can each be an open database connectivity (ODBC), or a Java database connectivity (JDBC).

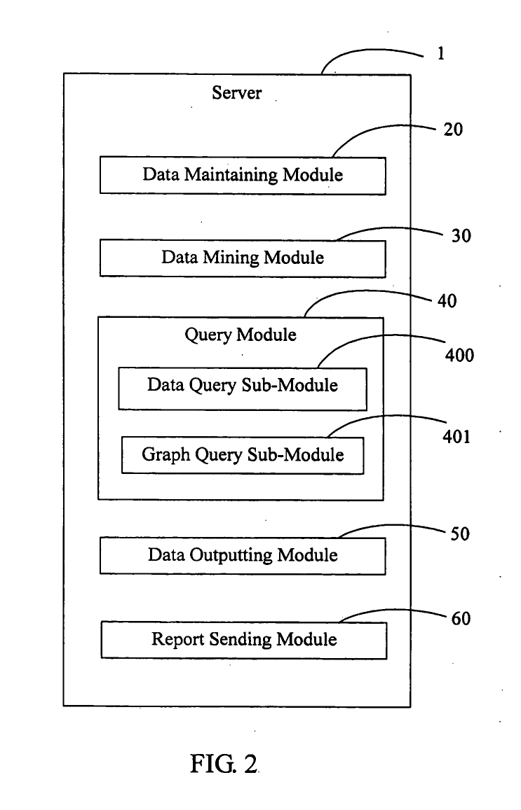

The server 1 comprises core and mutable enterprise logic (such as rules, execution, and management) of the system for global inventory querying. The server 1 comprises a plurality of software modules (described in detail below in relation to FIG. 2), and provides the function of global inventory querying.

The database 6 stores data on products and users, the products and users being located all over the world. The product data comprise data on IDs of warehouses where the products are stored, names of the warehouses, nations of the warehouses, IDs of the products, descriptions of the products, amounts, net weights and gross weights of the products, the unit price of each product, the total value of the products, clients, and forwarders of the products. The user data comprise data on electronic mail of users, designated inventory data the users want, and times of sending form reports. For example, a user may want to receive the inventory of a designated warehouse at 10:00 am every day. The branch database 7 stores data on inventory of that warehouse. The inventory data comprise data on IDs of the products, descriptions of the products, amounts, net weights and gross weights of the products, the unit price of each product, and the total value of the products.

The client computer 2 uses an operating environment such as Windows 95, Windows 98 or Windows NT, and provides an interactive user interface. The client computer 2 uses mschart control by Microsoft to query inventory in graphics. Via the client computer 2, the user can maintain the database 6 and the branch databases 7, obtain data from the server 1, and query inventory. The workstations 5 are distributed in different warehouses. The workstations 5 mine inventory data from different warehouses, and store the data in respective branch databases 7.

FIG. 2 is a block diagram of function modules of the server 1. The server 1 includes a data maintaining module 20, a data mining module 30, a query module 40, a data outputting module 50, and a report sending module 60.

The data maintaining module 20 is used to add, modify, delete and query inventory data stored in the database 6 and the branch database 7. The data mining module 30 mines inventory data from the branch database 7 via the workstation 3 and network 4, and stores the inventory data in the database 6. The inventory data comprise data on IDs of the products, descriptions of the products, amounts, net weights and gross weights of the products, the unit price of each product, and the total value of the products.

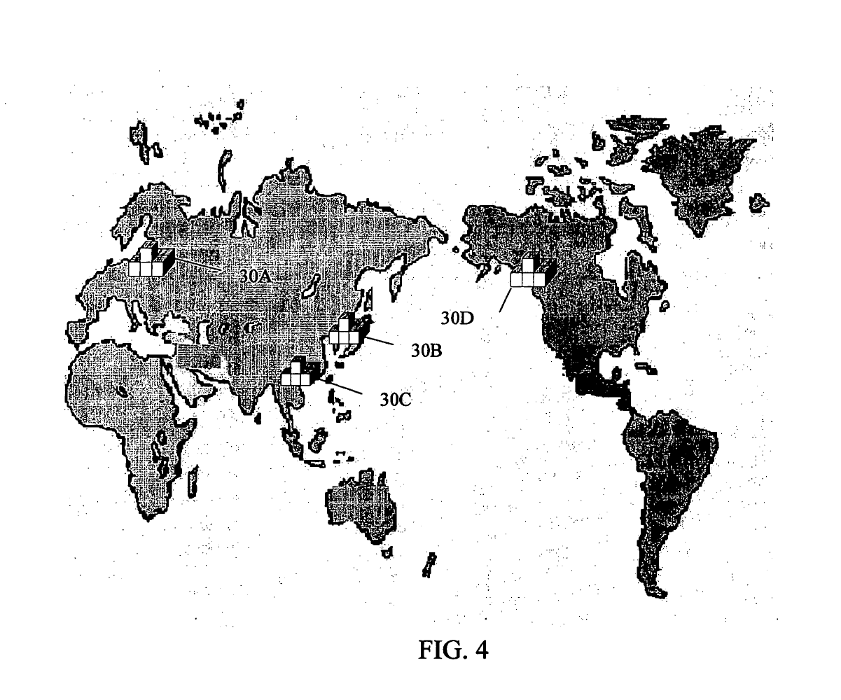

The query module 40 queries inventory data in accordance with a user's command. The query module 40 comprises a data query sub-module 400 and a graph query sub-module 401. Through the data query sub-module 400, the user can specify one or more parameters in order to query different inventory data from the database 6. The parameters comprise warehouses, product IDs, clients, and forwarders. For example, the user can obtain inventory data on a designated product by using the ID of the product. Through the graph query sub-module 401, the user can obtain inventory data on a designed warehouse. When using the graph query sub-module 401, the user logs on the server 1 to enter a graphical user interface showing inventory data of different warehouses (as described in detail below in relation to FIG. 4).

The data outputting module 50 is used to print the results of queries obtained in accordance with users' commands. The report sending module 60 is used to send a form report on inventory data to a corresponding user at a later time via electronic mail. The corresponding data required for sending electronic mail is stored in the database 6. Such data comprises electronic mail addresses, sending times, and contents of the form reports.

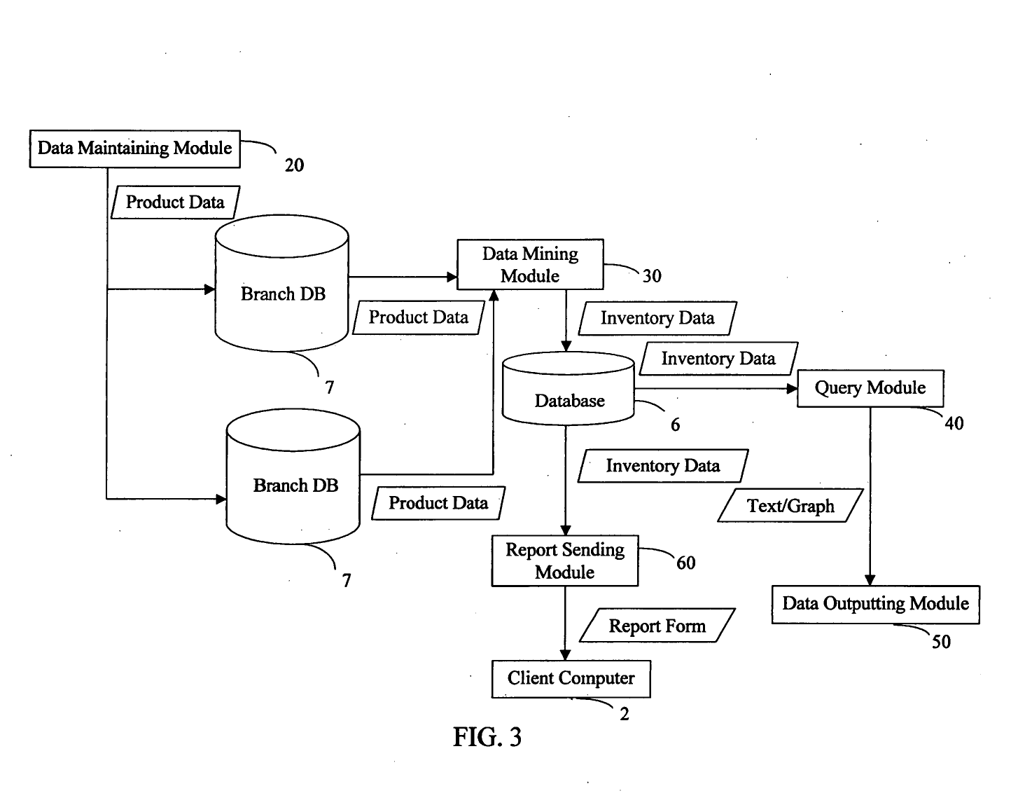

FIG. 3 is a data flow chart of the system for global inventory querying. The data maintaining module 20 maintains product data stored in the database 6 and the branch databases 7. Such maintaining comprises adding, modifying, querying, and deleting product data stored in the database 6 and the branch databases 7. The data mining module 30 mines inventory data on different products from the branch databases 7, and stores the inventory data in the database 6. The query module 40 specifies different parameters in accordance with users' query commands, and obtains various inventory data from the database 6. The parameters comprise warehouses, product IDs, clients, and forwarders. The data outputting module 50 prints results of querying in accordance with the users' commands. The report sending module 60 obtains various inventory data from the database 6 according to different users' commands, generates various form reports, and sends the form reports to various users via various client computers 2.

FIG. 4 is an exemplary querying website display of the system for global inventory querying. The website display comprises a world map. The world map is marked with a plurality of icons 30A, 30B, 30C, 30D (only these four are illustrated) where the corresponding warehouses are geographically located. When the user clicks one of the icons, the website display shows inventory of the corresponding warehouse in image form. The image form may comprise 2D (two dimensional) bar charts, 2D pie charts, 2D line charts, 2D area charts, 3D (three dimensional) bar charts, and 3D area charts.

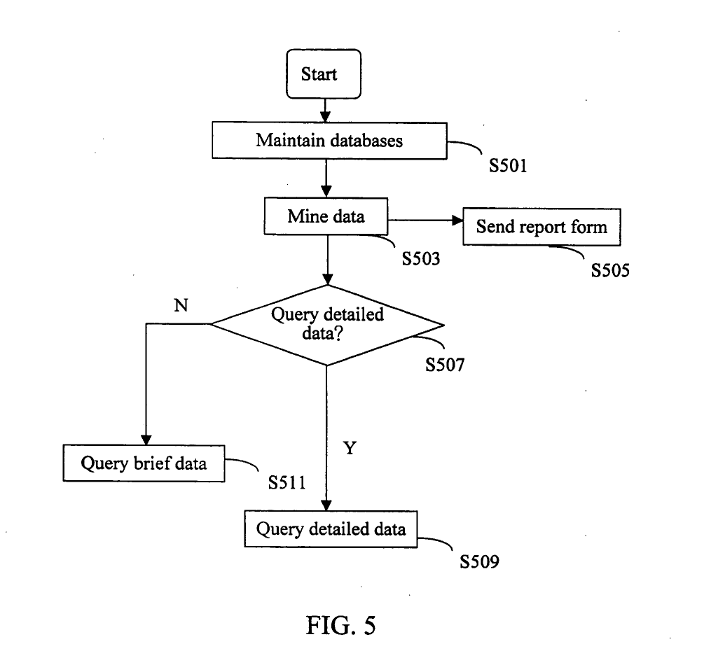

FIG. 5 is a flow chart of preferred operation of the system for global inventory querying. In step S501, the data maintaining module 20 maintains data stored in the database 6 and the branch databases 7 via the network 4 and the connections 5. The data maintaining module 20 can add, modify, and delete product data stored in the database 6 and the branch databases 7. In step S503, the data mining module 30 mines data on products from the branch databases 7 via the workstations 3, and stores the data in the database 6. In step S505, the report sending module 60 generates a form report on inventory in accordance with corresponding data stored in the database 6, the form report having designated contents. The report sending module 60 sends the form report to a corresponding user. The user can read the form report via one of the client computers 2. The designated contents vary according to different users, and a list of definitions of designed contents is stored in the database 6. In step S507, the query module 40 determines whether to query detailed data on inventory in accordance with input from the user. If the detailed data are required, in step S509, the data query sub-module 400 queries detailed data on inventory in accordance with parameters input by the user, and displays the detailed data to the user via one of the client computers 2. The parameters comprise warehouses, product IDs, clients, and forwarders. If brief data only are required, in step S511, the graph query sub-module 401 queries data on inventory of corresponding warehouses, and displays the data to the user in image form via one of the client computers 2. The image forms comprise 2D bar charts, 2D pie charts, 2D line charts, 2D area charts, 3D bar charts, and 3D area charts.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for global inventory querying, the system comprising a server, and a plurality of workstations connected with the server via a network, wherein:
each of the workstations is located in a corresponding warehouse, and connects with a respective branch database storing data on inventory of the warehouse; and
the server connects with a central database storing user data, the user data comprise contents of reports that corresponding users require, electronic mail details of the users, and times of sending reports, and the server comprises:
a data mining module for mining inventory data from the branch databases and storing the data in the central database;
a query module with a graphic query interface for querying inventory data; and
a report sending module for sending reports to corresponding users.

2. The system as claimed in claim 1, further comprising a plurality of client computers with graphical user interfaces, for users to maintain the central database and the branch databases and query inventory of products.

3. The system as claimed in claim 2, wherein each of the client computers comprises an mschart control by Microsoft to query inventory in graphics.

4. The system as claimed in claim 1, wherein the query module further comprises a data query sub-module for querying detailed inventory data.

5. The system as claimed in claim 1, wherein the query module further comprises a graph query sub-module for querying inventory data in image form.

6. The system as claimed in claim 5, wherein the graph query sub-module comprises a querying website, and the website comprises a world map marked with a plurality of icons corresponding to the warehouses.

7. A method for global inventory querying, the method comprising the steps of:
providing a workstation at each of warehouses, each of the workstations connecting with a respective branch database for storing inventory data on the warehouse;
providing a server connected with a central database, for storing data on users, contents of reports, electronic mail details and times of sending reports;
mining inventory data from the branch databases, and storing the mined data in the central database;
providing a graphic query interface for querying inventory data in image form; and generating a report on inventory, and sending the report to a corresponding user.

8. The method as claimed in claim 7, wherein the graphic query interface comprises a querying website, and the website comprises a world map marked with a plurality of icons corresponding to the warehouses.

9. The method as claimed in claim 7, wherein the image form comprises any one or more of a two dimensional (2D) bar chart, a 2D pie chart, a 2D line charts, a 2D area charts, a three dimensional (3D) bar chart, and a 3D area chart.
